(19) United States
(12) Patent Application Publication
(10) Pub. No.: US 2020/0216673 A1
(43) Pub. Date: Jul. 9, 2020

(54) THERMOPLASTIC SYNTHETIC TURF INFILL COMPRISING ORGANIC FILLER

(71) Applicant: Shaw Industries Group, Inc., Dalton, GA (US)

(72) Inventors: Philipe Aldahir, Chattanooga, TN (US); Fain Cochran, Cartersville, GA (US); Jason Kyzer, Atlanta, GA (US)

(21) Appl. No.: 16/737,125

(22) Filed: Jan. 8, 2020

Related U.S. Application Data
(60) Provisional application No. 62/789,686, filed on Jan. 8, 2019.

(51) Int. Cl. C08L 97/02; C08K 3/26; C08K 3/34; E01C 13/08

(52) U.S. Cl. CPC C08L 97/02; C08K 3/26; C08K 2003/265; E01C 13/08; C08K 3/346

(57) ABSTRACT

Disclosed is an improved particulate material for use as infill for a synthetic turf. Also disclosed is a method for the manufacture and use thereof.

This application claims the benefit of U.S. Provisional Application No. 62/789,686, filed on Jan. 8, 2019, which is incorporated herein in its entirety.

### TECHNICAL FIELD

This invention relates generally to synthetic turf and, more specifically, to particulate infill material comprising a blend of thermoplastic elastomer and organic filler.

### BACKGROUND

Generally, artificial turf is a synthetic turf system including a grass layer made of a plurality of pile-fibers and an infill composed of particles or chips and provided between the pile-fibers. Since the advent of artificial turf systems, crumb rubber, recycled from car tires, has been the most prevalent type of particulate infill used. While serving as a mass outlet for the car/recycling industry, crumb rubber does not contribute to create a high performance turf system and has several drawbacks.

Crumb rubber is loose, bouncy, and squishy, resulting in less than ideal rotational traction, excessive surface vertical deformation, and extreme energy rebound. Lower rotational traction results in less than ideal athletic performance, once athletes have difficult in anchoring while start/stopping, or changing directions. Excessive vertical deformation can affect athletic posture and kinematics parameters (running on a mattress). Extreme energy rebound back to the athlete may cause muscle fatigue, body soreness, and may contribute to lower extremity injury. Excessive vertical deformation and energy rebound also affect the interaction between the ball and the surface, causing excessive or unnatural ball bounce.

Since crumb rubber chips typically have a black color, they can absorb radiation from the sun, substantially raising the temperature of the playing field up to 2× compared to a natural surface, thereby deteriorating the environment for athletic play. Moreover, in extreme heat, undesirable odors can be observed, the rubber chips can melt or deform under geothermal heat, thereby becoming sticky and agglomerating; toxic gases can be released; and low water content and large frictional heat of the rubber chips cause a risk of abrasion or burning when users or athletes slip, slide, or fall down.

Furthermore, many concerns have surfaced time and time again, and continue to appear, regarding the chemical properties of crumb rubber and its potential environmental and human health risk. This invention relates to an improved environmentally friendly infill material. The infill material can comprises an “Eco-elastomer” with superior attributes to crumb rubber regarding material chemistry and safety, recycled content, organic/natural content, and superior surface properties for sports playing

### SUMMARY

The present disclosure is directed generally to artificial turf systems and more specifically to an improved particulate material suitable for use as an infill material.

In one aspect, the invention provides a particle suitable for use as a synthetic turf infill, comprising at least one thermoplastic elastomeric material and one or more filler component.

In another aspect, the invention provides a method for making the particles disclosed herein.

In another aspect, the invention provides a method comprising infilling a synthetic turf with the particulate infill material disclosed herein.

In another aspect, the invention provides an artificial turf installation comprising the particulate infill disclosed herein.

Additional aspects of the invention will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

FIG. 1 shows an exemplary extrusion process of a thermoplastic elastomer disclosed herein.

FIG. 2 shows an exemplary extrusion process that introduces an organic filler into the thermoplastic elastomer.

FIG. 3 shows the process of the extrudate from FIG. 2 being pelletized, segregated, and cooled.

FIG. 4 shows the extrudate from FIG. 2 after being processed into a sheet of material.

FIG. 5 shows a magnified cross sectional view of an exemplary wood powder filled thermoplastic elastomer particulate infill as disclosed herein.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, or steps. Furthermore, it is to be understood that the terms comprise, comprising and comprises as they related to various aspects, elements and features of the disclosed invention also include the more limited aspects of “consisting essentially of” and “consisting of.”

As used herein, the singular forms “a,” “an” and “the” include plural referents unless the context clearly dictates otherwise. Thus, for example, reference to a filler includes aspects having two or more such fillers unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As summarized above, in a first aspect, the present provides an improved particulate material suitable for use as infill material in an artificial turf installation. The particulate material comprises at least one thermoplastic elastomeric material and at least one filler component. As an alternative to conventional rubber crumb based infill materials, in some aspects the particulate material does not comprise any rubber component. As such, in one aspect, the particle does not comprise rubber crumbs.

Also disclosed is a synthetic turf comprising the particle disclosed herein. Also disclosed is a synthetic turf installation comprising a primary backing having a face side and a backside, a plurality of yarns tufted into the primary backing and extending substantially vertically away from the face side thereof and infill disposed between the yarns, wherein the infill comprises a particle disclosed herein.

In one aspect, the particle has a particle size in the range of from 45 to 200 microns. For example, the particle can have an average particle size in the range of from 45 to 200 microns. In another example, the particle can have an average particle size in the range of from 75 to 200 microns. In another example, the particle can have an average particle size in the range of from 100 to 200 microns. In another example, the particle can have an average particle size in the range of from 150 to 200 microns. In another example, the particle can have an average particle size in the range of from 45 to 150 microns. In another example, the particle can have an average particle size in the range of from 45 to 100 microns.

The thermoplastic elastomeric material portion of the particle can be comprised of any thermoplastic elastomer material known for use in turf infill materials. Specific examples include styrenic block copolymers, polyolefin blends (TPOs), elastomeric alloys, thermoplastic polyurethanes (TPUs), thermoplastic copolyesters and thermoplastic polyam ides. For example, the thermoplastic elastomer can comprise a styrenic block copolymer. In another example, the thermoplastic elastomer can comprise a polyolefin blend. In another example, the thermoplastic elastomer can comprise an elastomeric alloy. In another example, the thermoplastic elastomer can comprise a thermoplastic polyurethane. In another example, the thermoplastic elastomer can comprise a thermoplastic copolyester. In another example, the thermoplastic elastomer can comprise a thermoplastic polyamide.

The filler component portion of the particulate material can comprise organic filler material, inorganic filler material, or a combination of both inorganic and organic filler material. For example, the particulate material can comprise an organic filler. In another example, the particulate material can consist of an organic filler. In another example, the particulate material can consist essentially of an organic filler. In another example, the particulate material can comprise an inorganic filler. In another example, the particulate material can consist of an inorganic filler. In another example, the particulate material can consist essentially of an inorganic filler. In another example, the particulate material can comprise an organic filler and an inorganic filler.

Exemplary organic filler material that can be used in the particulate material can include cellulosic fibers from plant materials, such as wood based material. The wood based material can be from any wood source. In one aspect the wood source can be bark material. In other aspects, the wood source does not comprise bark. The wood based material can be virgin wood based material or can be obtained as scrap or manufacturing remnants from processes or facilities that result in the formation of scrap or waste wood products. As such, the scrap or manufacturing remnants are reclaimed from a manufacturing waste stream . Examples of such processes can include wood flooring manufacturing process, furniture manufacturing processes, logging or deforestation facilities, sawmills, lumber yards and the like. For example, the manufacturing scrap can be a manufacturing waste stream from a wood flooring manufacturing process.

Exemplary inorganic filler materials that can be used in the particulate material can include mineral oxides, calcium carbonate, clays such as kaolin clay, nanoclays, kaolinite, illite, montmorillonite, feldspar, silica, sand, quartz and the like. For example, the inorganic material can comprise calcium carbonate or kaolin clay, or a combination thereof. In another example, the inorganic material can comprise calcium carbonate. In another example, the inorganic material can comprise kaolin clay.

The relative amount by weight or ratio of filler to thermoplastic elastomer component can be any desired ratio based upon the desired properties to be obtained in the particulate infill material. For example, in some aspects the particle can comprise an amount of filler in the range of from 20 weight percent to 80 weight percent based upon the total weight of the particulate material. In a further aspect, the amount of filler can be any specific amount falling within the disclosed range, including exemplary filler amounts of 25, 30, 35, 40, 45, 50, 55, 60, 65, 70, or 75 weight percent. In still another aspect, the amount of filler can be at least any of the aforementioned amounts, such as for example, at least 50 weight percent. In another aspect, the amount of filler can an amount in a range derived from any two of the aforementioned values, including for example, in a range of from 50 to 80 weight percent. In an exemplary aspect, the particulate infill material can comprise about 50 weight percent wood filler, about 30 weight percent of a thermoplastic elastomer; and about 20 weight percent of an inorganic filler material, such as calcium carbonate.

The particulate infill material can optionally comprise one or more additives in addition to the filler component and thermoplastic elastomer. Such additives can, for example, include an additive suitable for imparting anti-clumping properties to the particulate material; a flame retardant additive, or an antimicrobial additive.

The filler component is preferably in the form of a powder. The powder can be, for example, a powder having an average particle size in the rage of from 45 to 200 microns. In another example, the powder can have an average particle size in the range of from 75 to 200 microns. In another example, the powder can have an average particle size in the range of from 100 to 200 microns. In another example, the powder can have an average particle size in the range of from 150 to 200 microns. In another example, the powder can have an average particle size in the range of from 45 to 150 microns. In another example, the powder can have an average particle size in the range of from 45 to 100 microns.

The particulate infill material of the present invention can exhibit one or more of a variety of desired properties. In an exemplary aspect, the particulate infill is engineered to exhibit properties that are the same as or substantially similar to that of convention crumb rubber based infill materials. This can include desired particle size, uniformity of particle size, a desired particle size distribution, specific gravity, flowability, bulk density, anti-clumping, anti-microbial properties, moisture permeation properties, moisture absorption or moisture evaporative cooling features, or any combination thereof.

In another aspect, the present invention provides a method for making the particulate infill material described herein. Disclosed is a method of making a particle disclosed herein, comprising a) forming a blend comprising the thermoplastic elastomer and the filler component; and b) forming the particle from the blend. In one aspect, the particle is formed by an extrusion process. The method can further comprise the step of granulating the particle to provide a particle having a desired particle size. In one aspect, the desired particle size can be an average particle size in the rage of from 45 to 200 microns. In another example, the desired particle size can be an average particle size in the range of from 75 to 200 microns. In another example, the desired particle size can be an average particle size in the range of from 100 to 200 microns. In another example, the desired particle size can be an average particle size in the range of from 150 to 200 microns. In another example, the desired particle size can be an average particle size in the range of from 45 to 150 microns. In another example, the desired particle size can be an average particle size in the range of from 45 to 100 microns.

As such, the method generally comprises blending the thermoplastic elastomeric component with the filler component and forming the particulate material from the blend. In one aspect, an extrusion process can be used. In an exemplary extrusion process, a blend of the thermoplastic elastomer and filler can be formed prior to extrusion or during the extrusion process. In either case, the extrusion process produces pellets of material of the blended material which can then be subjected to a granulation process to size reduce the formed pellets to a desired size. Optionally, the sized reduced material can then be further screened in a segregation process to isolate the final particulate infill material having a desired particle size. As one of ordinary skill in the art will appreciate, processing conditions during the manufacturing process can be selected depending on the composition of the filler material present. For example, organic wood based filler can be processed under conditions that will not negatively impact or degrade the wood filler itself.

In another aspect, the present invention is directed to methods comprising infilling a synthetic turf athletic field with particulate material as described above.

In another aspect, the present invention is directed to synthetic turf structures comprising a primary backing having a face side and a back side; a plurality of yarns tufted into the primary backing and extending substantially vertically away therefrom the face side thereof; and an infill as described herein disposed within gaps formed between the tufted yarns. The disclosed synthetic turf structure can be used as an athletic field, a playground, a safety surface, a running or walking trail, a landscaping walkway, or an equestrian footing application. In some of these embodiments, the primary backing sheet is constructed of woven or non-woven polypropylene or polyester, the plurality of fibers that are tufted into the primary backing sheet and extend away therefrom are constructed of a polymeric material, such as a polypropylene, a polyester, nylon, a polyolefin (including polypropylene or polyethylene), or other polymers and are, in some embodiments, colored so as to simulate natural grass or turf, and the synthetic turf structure also comprises a backing coating that is constructed of, for example, a polyurethane elastomer. The backing coating is adhered to the primary backing sheet and locks the fibers into the primary backing sheet.

### EXAMPLES

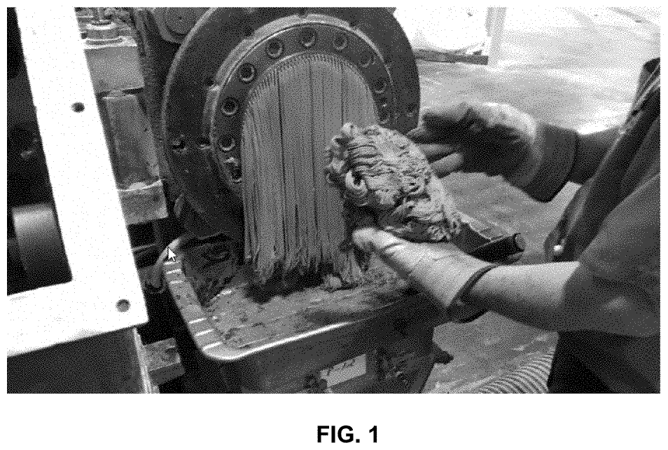

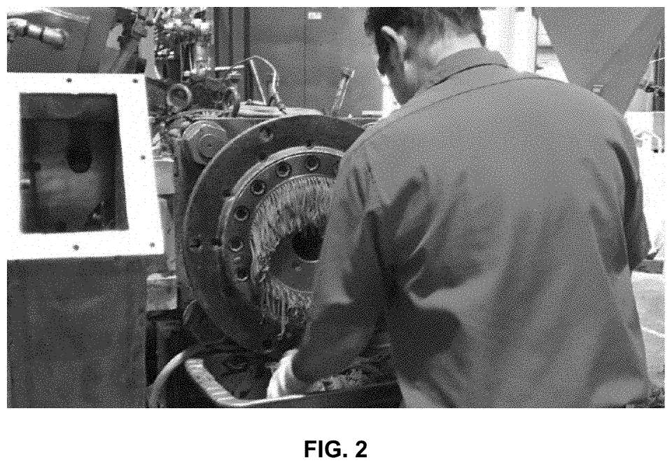

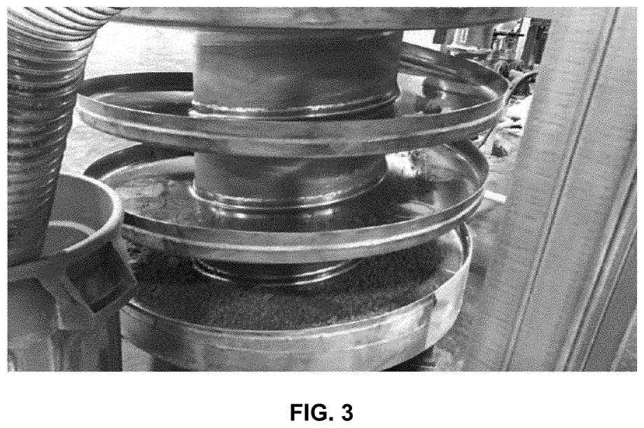

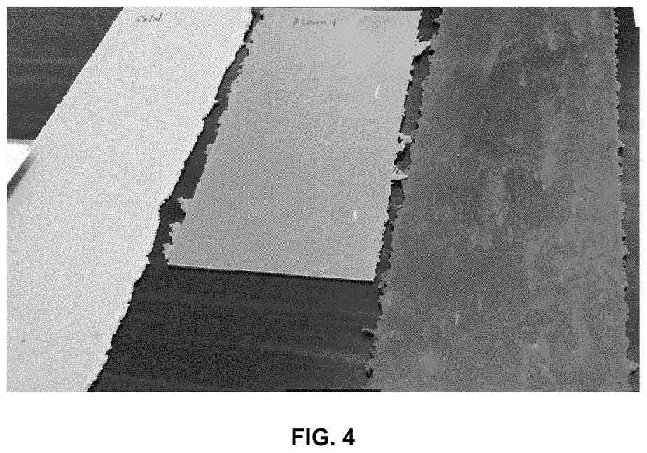

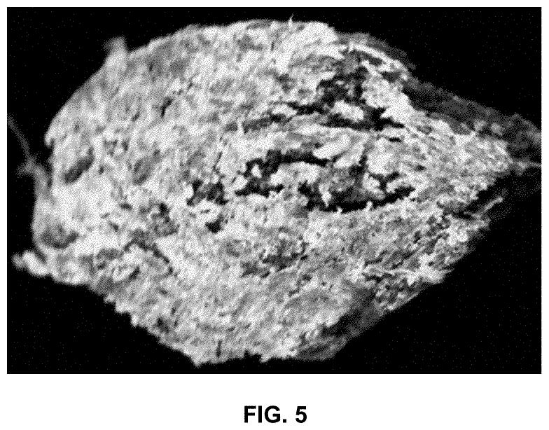

An exemplary process for manufacturing a particulate filler material of the present invention is shown in FIGS. 1-5. The exemplary particulate infill material was comprised of thermoplastic elastomer loaded with powdered wood filler present in a loading amount of 50% by weight of the overall particulate composition. First, as shown in FIG. 1, a desired thermoplastic elastomer component portion can be processed through an extrusion process. This can develop desired viscosity in the thermoplastic composition prior to introduction of any organic filler material. The desired organic filler material can then be introduced into the thermoplastic elastomer portion in a subsequent extrusion process as shown in FIG. 2. Following the subsequent extrusion and filler introduction process, the resulting extrudate can be pelletized, then segregated and cooled as shown in FIG. 3. Alternatively, as shown in FIG. 4, the extrudate can also yield a sheet of material. These sheets of material can be ground up further, and screened in a size reduction process to obtain the desired infill particle size. FIG. 5 shows a magnified cross sectional view of an exemplary wood powder filled thermoplastic elastomer particulate infill as disclosed herein. As illustrated, particulate wood filler material can be seen.

1. A particle suitable for use as a synthetic turf infill, comprising at least one thermoplastic elastomeric material and one or more filler component.

2. The particle of claim 1, wherein the particle does not comprise rubber.

3. The particle of claim 1, wherein the particle comprises from about 20 weight percent to about 80 weight percent of the one or more filler component.

4. The particle of claim 1, wherein at least 50 weight percent of the particle is comprised of the one or more filler component.

5. The particle of claim 1, wherein the one or more filler component comprises and inorganic filler.

6. The particle of claim 1, wherein the filler component comprises an organic filler.

7. The particle of claim 6, wherein the organic filler comprises wood based material.

8. The particle of claim 1, wherein the filler component comprises and inorganic filler.

9. The particle of claim 8, wherein the inorganic filler comprises calcium carbonate, kaolin clay, or a combination thereof.

10. The particle of claim 7, wherein the wood based material is manufacturing scrap reclaimed from a manufacturing waste stream.

11. The particle of claim 10, wherein the manufacturing scrap is a manufacturing waste stream from a wood flooring manufacturing process.

12. The particle of claim 1, wherein the particle has a particle size in the range of from 45 to 200 microns.

13. The particle of claim 1, wherein the thermoplastic elastomer comprises at least one of a styrenic block copolymer, polyolefin blends (TPOs), elastomeric alloys, thermoplastic polyurethanes (TPUs), thermoplastic copolyesters, or thermoplastic polyam ides.

14. The particle of claim 1, wherein a plurality of the particles exhibit uniformity of particle size, flowability, anti-clumping, anti-microbial properties, moisture permeation properties, moisture absorption or moisture evaporative cooling features, or any combination thereof.

15. A method comprising infilling a synthetic turf installation with the particle of claim 1.

16. A synthetic turf installation comprising a primary backing having a face side and a backside, a plurality of yarns tufted into the primary backing and extending substantially vertically away from the face side thereof and infill disposed between the yarns, wherein the infill comprises the particle of claim 1.

17. A method of making the particle of claim 1, comprising
a) forming a blend comprising the thermoplastic elastomer and the filler component; and
b) forming the particle from the blend.

18. The method of claim 17, wherein the particle is formed by an extrusion process.

19. The method of claim 17, further comprising granulating the particle to provide a particle having a desired particle size.

20. A method comprising infilling a synthetic turf installation with the particle produced by the method of claim 17.
